(19) United States
(12) Patent Application Publication
(10) Pub. No.: US 2010/0162908 A1
(43) Pub. Date: Jul. 1, 2010

(54) Method and apparatus for manual rubber stamp printing

(76) Inventor: Irene Prior, Lancaster, CA (US)

Correspondence Address: Irene Prior, 4379 Paddock Way, Lancaster, CA, 93536, US

(21) Appl. No.: 12/317,725

(22) Filed: Dec. 29, 2008

(51) Int. Cl. B41L 27/26

(52) U.S. Cl. 101/125

(57) ABSTRACT

A method and apparatus that substantially improve quality of a stamped image, particularly as used with large or complex artistic hand stamps. Manufacturing cost of said apparatus is substantially less than presently-available and comparably-performing stamp presses.

### STATEMENT REGARDING FEDERALLY-SPONSORED RESEARCH OR DEVELOPMENT

Not Applicable

### FIELD OF THE INVENTION

This invention relates to the field of rubber stamps, particularly to the printing of artistic rubber stamp images.

### BACKGROUND OF THE INVENTION

Handheld rubber stamps have been used for years to imprint words or images onto paper and have become a mainstay of many greeting card artists. Generally, stamping comprises a two-step process; a) apply ink (via an ink pad or roller) to said rubber stamp, and b) press said inked stamp firmly onto paper.

For stamp sizes less than two square inches or so, the transfer process generally provides an acceptable image with relatively-modest applied pressure. However, as the complexity or size of a transferred image increases, several problems are encountered. These are as follows.

Ink coverage, as applied via an ink pad or ink roller, of the rubber stamp may be less-than-complete, thus resulting in a stamped image that is also incomplete or varies unacceptably in density. Said problem results from a number of issues such as ink pad ink distribution inconsistencies, ink roller unevenness (pressure or ink coverage), or a user's own inability to judge the ink coverage of a stamp.

Furthermore, manually-applied pressure to a stamp may be uneven across the total area of a stamp-paper interface, thus resulting in a stamped image density that varies according to local pressure applied. For example, the left side of a stamped image may be lighter than the right side if a user applies more pressure to the right side of the stamp. Manually applying proper pressure, and doing so evenly, across a large stamp often requires much practice or much trial-and-error, thereby requiring large quantities of ink and supplies.

Also, the rubber stamp itself may be uneven across its inking surface, thus the density of applied ink may be proportional to the relative height of the stamp surface to paper used to receive said ink, i.e., an uneven stamp can print an uneven image (with regard to image density). Said problem is exacerbated by the use of large stamps, wherein tight in-plane tolerances must be met over a proportionally large area.

The aforementioned problems are alleviated—at least, in part—by the use of a manually-operated printing press wherein a stamp is inked then subsequently placed in a vise-like apparatus that applies heavy pressure to the stamp-paper interface. This method is, of course, hundreds of years old, and the fundamental practice remains unchanged.

While said printing method works well for professional stampers, many stamping hobbyists cannot afford the often-bulky and precision-made printing press. Although inexpensive versions of printing presses are commercially available, many of these products are prone to image quality issues that are evident with manual stamping methods; i.e., if ink distribution is uneven across a stamp, the resulting stamped image will also be uneven. This is a problem compounded by the use of large or complex stamps.

Some artists have used a simple fold-over method for manually printing small quantities of greeting cards. With said method a stamper; a) folds a blank greeting card in half, b) then places an inked stamp upside-down on a work surface, c) then lightly places the blank greeting card front cover on the top of the inked stamp, roughly aligning the edges of the paper with the edges of the inked stamp, and d) subsequently uses fingertip pressure on the double-thickness paper to transfer the inked image to the greeting card front cover. Although this manual method can ameliorate the problems of uneven stamp surfaces and provide, with practice, a more-consistent image, several problems are encountered; a) re-inking of a stamp—if required to correct a spotty image—is not practical (paper and stamp would likely be misaligned on the second printing), b) the stamped image needs to be roughly the size of the greeting card, otherwise precise positioning (for example, centering a small image on a large card) is difficult, and c) the method is still a get-it-right-the-first-time technique, i.e., if a novice applies too little fingertip pressure or too much, the greeting card may need to be rejected.

Thus, because manual stamping methods (traditional and upside-down) require much practice, and large printing presses are expensive, many stamping hobbyists simply avoid large and complex stamps.

The present invention solves the aforementioned rubber stamp problems with both a novel printing method and printing apparatus as shown in FIG. 1 preferred embodiment and as described below.

### OBJECTIVES OF THE INVENTION

It is a primary objective of this invention to enable consistent and reliable reproductions of artistic rubber-stamp impressions.

It is a further objective of this invention to achieve the aforementioned objective via a compact, cost-effective device.

Other objectives, advantages and novel features of the invention will become more apparent from the following detailed description when taken in conjunction with the accompanying drawings.

### BRIEF DESCRIPTION OF DRAWINGS

FIG. 1 is a perspective drawing of a preferred embodiment of this invention.

FIG. 2 is a perspective drawing of a preferred embodiment as used with an exemplary rubber stamp.

FIG. 3 is a perspective drawing that depicts print paper installed in a preferred embodiment.

### DETAILED DESCRIPTION OF A PREFERRED EMBODIMENT

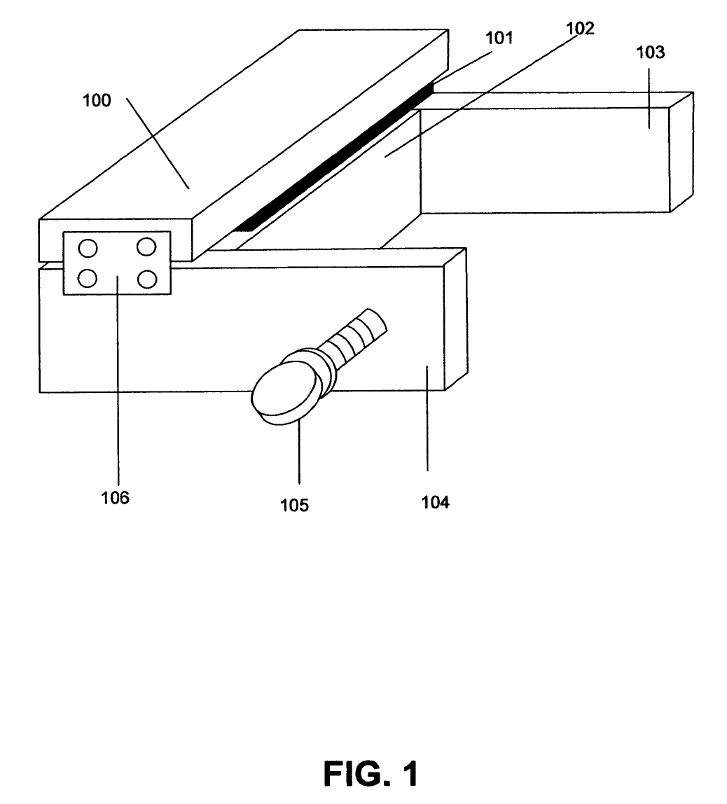

FIG. 1 depicts two key elements of this invention in a preferred embodiment; rubber stamp holder comprising components 102-105 and print paper clamp mechanism comprising components 100, 101, and 106. The size of this invention is dependent on the widths and lengths of rubber stamps to be used, however, typically the apparatus is about 6-10 inches long (determined by the length of print paper clamp mechanism 100) and about 3 inches wide (determined by the width of rubber stamp positioning components 103 and 104).

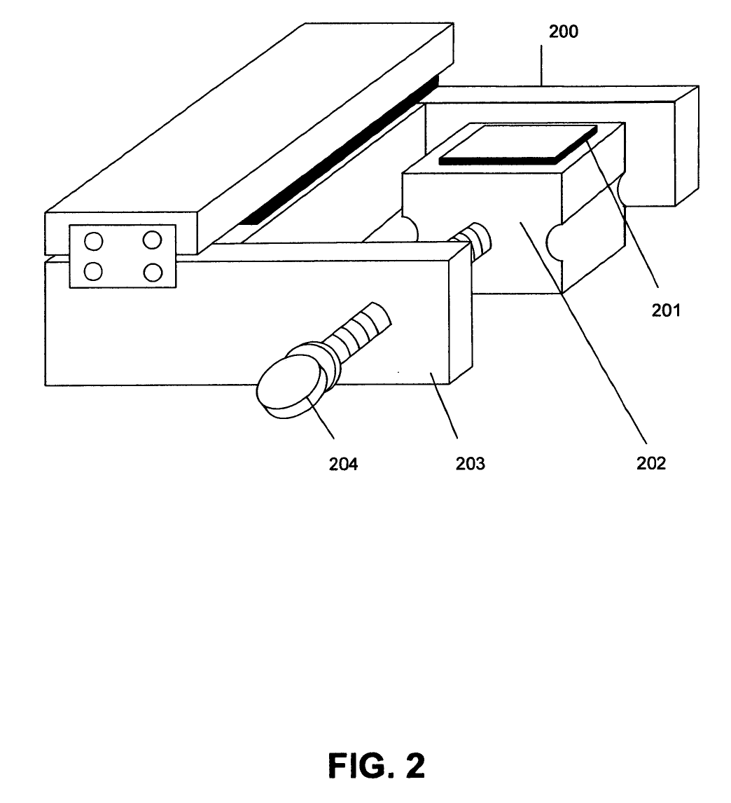

FIG. 2 depicts a preferred embodiment as used with an exemplary rubber stamp wherein said rubber stamp is placed printing-surface-up within the apparatus. Although the length and width of stamp base 202 and rubber stamp image surface 201 vary according to size of the printed image, the height of said stamp is typically an industry-standard one inch. As depicted in this preferred embodiment, the apparatus base is open allowing a user to place said stamp directly on a table top, thus minimizing the material required to construct this invention. Also, by minimizing the size of said rubber stamp printing apparatus, storage space, which is often a premium for artists, is minimal.

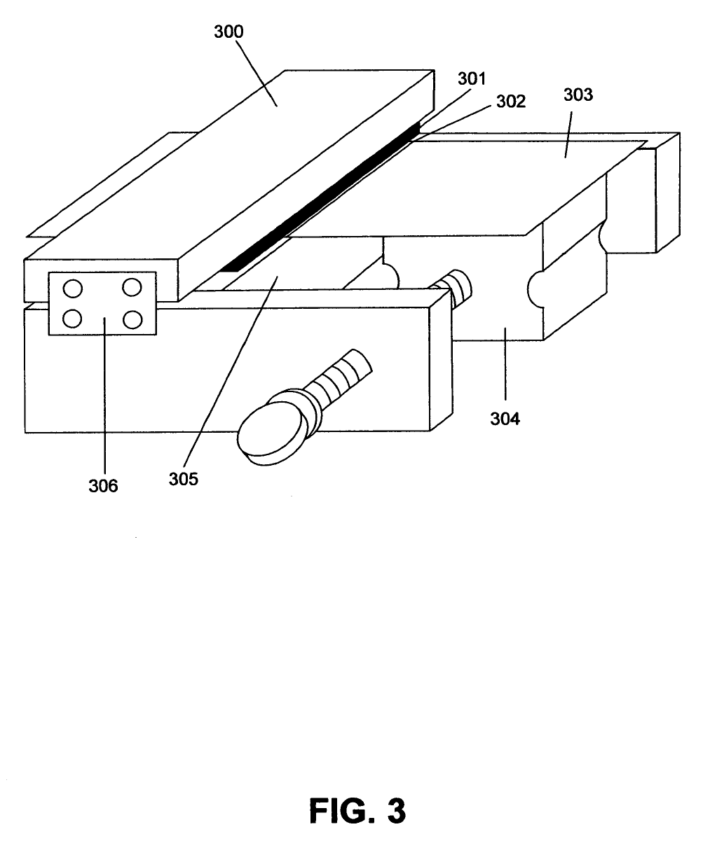

After positioning said stamp against support arm 200, a user subsequently clamps it in place by tightening thumbscrew 204. FIG. 3 depicts the next step in printing wherein one end of paper clamp 300 is rotated about hinge 306 (far end of paper clamp is unhinged and unclamped). Subsequently the user inserts print paper 303 and, after properly positioning said paper, clamps it in place by closing 300 and latching it in place (a hook and staple latch on the far end is not shown). A rubber strip 301 gently holds the print paper in place while the next step is performed. As shown in FIG. 3, the height of support arm 305 is such that paper 303 remains level with the stamp image surface.

Printing of greeting cards is a primary use of this invention, and as such, paper 303 can be pre-creased at its center. Said pre-creasing allows a user to easily lift the image half of paper 303 up and away from the rubber stamp. Said lifting is a prelude to the next step in printing.

Subsequent to a user lifting the image half of the print paper, the rubber stamp image surface 201 is inked. To ease inking, the print paper can be held upright by, for example, a sliding clip (not shown) along the top or front (stamp direction) of arm 300. After inking the rubber stamp surface, a user next lowers paper 303 such that the paper surface gently rests on the inked surface. Next the user applies fingertip pressure to gently press the topside of paper 303 against the inked surface and does so with small sweeping motions until the entire image has been pressed. Said method easily overcomes any unevenness in the rubber stamp surface and generally produces an acceptable printed image. The user can check the quality of said image by again lifting the printed half of paper 303 and looking at the inked image. Because clamp 300 maintains good paper-to-stamp registration, the user can re-ink the rubber stamp as required and re-stamp the paper. Said examination and re-inking process can be repeated as required until an acceptable image is produced. Generally a novice user would start with relatively-light pressure, then work towards heavier pressure where needed. Because re-stamping image alignment is good, a user does not necessarily need to “get it right the first time.”

After a successful printing, the user unlatches and lifts clamp 300, allowing paper 303 to be easily removed. A new, clean sheet of pre-creased paper can then be inserted. Because said print paper is pre-creased and the image half is held upright by the user, any residual rubber stamp ink should not be transferred to print paper until the user is ready for printing.

As this apparatus and printing method are manually intensive, said device is not necessarily applicable to mass-production printing. However, for small-volume artistic stamping, this invention allows reliable reproduction of a wide variety of rubber stamp images-and does so with minimal cost investment. Other embodiments based on the disclosed invention should be readily apparent to those familiar with rubber stamping or the fabrication of small tools.

What is claimed is:

1. A rubber-stamp printing apparatus comprising a rubber stamp positioning means and a print paper clamping means, wherein;
a) a user of said apparatus can adjust and fix the relative positions of said paper clamping means and said rubber stamp, and
b) said rubber-stamp positioning means allows said rubber stamp to be oriented image-side-up, and
c) said print paper clamping means allows positioning of said print paper surface at the same level as the rubber image surface, and
d) said print paper clamping means allows a user to examine a stamped image and subsequently re-ink and re-stamp said print paper with minimal image misalignment, and
e) said apparatus allows stamping process via fingertip pressure or light mechanical pressure means, and wherein said pressure means is applied to said print paper on the non-image side, resulting in print-paper-to-inked-surface contact, and wherein said pressure is applied in small sections of said image area, cumulatively covering the entire area of said image.

2. An apparatus of claim 1 wherein said rubber stamp positioning means includes a clamp that allows adjustment and subsequent fixing of the relative positions of said rubber stamp and print paper.

3. An apparatus of claim 1 wherein installable, adjustable, or otherwise movable spacers are placed within said apparatus to allow centering or positioning of said rubber stamp with respect to print paper edges.

4. An apparatus of claim 1 wherein fixed spacers are included in said apparatus to allow centering or positioning of said rubber stamp with respect to print paper edges.

5. An apparatus of claim 1 wherein said stamp positioning means includes a rubber, or other non-slippery material, pad or mat.

6. An apparatus of claim 1 that includes a means to hold the image area of said print paper upright or nearly upright during rubber stamp inking and/or print inspection.

7. An apparatus of claim 1 that includes a means to position a plurality of stamps for use during a printing process.

8. An apparatus of claim 1 wherein additional means are provided to further support and/or align print paper.

9. An apparatus of claim 1 wherein the stamp-positioning means allows printing with a vertically-oriented rubber stamp surface.
